(19) United States
(12) Patent Application Publication
(10) Pub. No.: US 2025/0263873 A1
(43) Pub. Date: Aug. 21, 2025

(54) HYBRID FABRIC

(71) Applicant: Owens Corning Intellectual Capital, LLC, Toledo, OH (US)

(72) Inventor: Chloé Bertrand, Marcq en Baroeul (FR)

(21) Appl. No.: 18/859,248

(22) PCT Filed: Apr. 21, 2023
(86) PCT No.: PCT/EP2023/060529

§ 371 Date: Oct. 23, 2024

(30) Foreign Application Priority Data
May 4, 2022 (EP) 22305666.4

(51) Int. Cl. D04H 1/4374; B32B 5/06; B32B 5/12; D02G 3/18; D02G 3/24; D02G 3/34; D04H 1/4218; D04H 1/4242; D04H 1/435; D04H 1/4382; D04H 1/498; D04H 1/74

(52) U.S. Cl. CPC D04H 1/4374; B32B 5/073; B32B 5/12; D02G 3/18; D02G 3/24; D02G 3/34; D04H 1/4218; D04H 1/4242; D04H 1/435; D04H 1/43835; D04H 1/498; D04H 1/74; B32B 2250/20; B32B 2262/0284; B32B 2262/101; B32B 2262/106; B32B 2262/16; B32B 2307/718; D10B 2101/06; D10B 2505/02

(57) ABSTRACT

Herein is described a carbon fiber and glass fiber hybrid fabric having a total areal weight of less than about 500 g/m².

### FIELD OF THE INVENTION

The present invention relates to hybrid fabrics including carbon fibers and glass fibers, in particular hybrid fabrics useful to be combined with reinforcement elements in structural components such as wind turbine blades or related components such as a spar cap.

### BACKGROUND

Carbon fiber reinforcement materials are conductive as well as exhibiting good mechanical properties, including stiffness and tensile strength, at a low density. Therefore, carbon fiber reinforcement materials are useful to reinforce structural components such as wind turbine blades or related components.

It is known to use pultruded carbon fibers to reinforce structural components, such as wind turbine blades or related components such as a spar cap. These structural components are often formed by laying carbon pultruded planks into a mold, filling the mold with a resin, and curing the resin to form the part.

Conventionally, wind turbine blades were made from non-conducting materials such as glass fiber reinforced polymers/plastics. However, the incorporation of conducting reinforcement components, such as carbon components, in wind turbine blades in order to minimise damage to wind turbine blades during lightning strikes has created new challenges.

Carbon fiber reinforcement materials, such as pultruded carbon fiber planks, used in the production of wind turbine blades or related components may be joined together using hybrid fabrics comprising carbon fibers and glass fibers that may be more easily infused with a resin than the carbon reinforcement materials such as pultruded carbon fiber planks, as well as providing a conductive layer between pultruded carbon fiber planks.

It would be desirable to provide a hybrid fabric that is lightweight, dimensionally stable and also resistant to handling to allow the efficiency of the production of wind turbine blades or related components to be improved.

### SUMMARY OF THE INVENTION

At its most general, the present invention provides a carbon fiber and glass fiber hybrid fabric having a total areal weight of less than about 1000 g/m², for example less than about 500 g/m². The hybrid fabric may comprise: a first layer comprising first fibers comprising carbon fibers oriented in a first direction; and a second layer comprising second fibers which are stabilization fibers oriented in a second direction, the first and second fibers maintained in their respective orientations by a stitching yarn, the areal weight of the fabric being less than about 1000 g/m², for example less than about 500 g/m².

The present inventors have found that the present invention allows the provision of easy to handle and dimensionally stable hybrid fabrics having a low total areal weight (i.e. less than about 1000 g/m², for example less than about 500 g/m²) which are useful in the production of wind turbine blades or related components, particularly wind turbine blades or related components comprising carbon fiber pultruded planks. The present inventors have also found that the provision of such hybrid fabrics improves the efficiency of production of the wind turbine blades or related components.

In a first aspect, the present invention provides a carbon fiber and glass fiber hybrid fabric comprising:
a first layer comprising first fibers oriented in a first direction;
a second layer comprising second fibers oriented in a second direction;
a stitching yarn maintaining the fibers of the first and second layers in their respective orientations,

wherein the second direction is within about 45 degrees to about 90 degrees of the first direction,

the first fibers comprise carbon fibers,

the second fibers comprise stabilization fibers,

the areal weight of the fabric is less than about 500 g/m²

the first fibers constitute at least about 15 wt. % of the fabric, and

the second fibers constitute less than about 50 wt. % of the fabric.

In a second aspect, the present invention provides a method for producing a carbon fiber and glass fiber hybrid fabric, the method comprising:
providing a first layer comprising first fibers oriented in a first direction, the first fibers comprising carbon fibers;
providing a second layer comprising second fibers oriented in a second direction, the second fibres comprising stabilization fibers, the second layer disposed on the first layer, the second direction being within about 45 degrees to about 90 degrees of the first direction;
stitching the first and second layers together using a stitching yarn to form the hybrid fabric having an areal weight of less than about 500 g/m²,

wherein the first fibers constitute at least about 15 wt. % of the fabric, and the second fibers constitute up to about 50 wt. % of the fabric.

In a third aspect, the present invention provides a composite article comprising a hybrid fabric as described herein.

In a fourth aspect, the present invention provides a wind turbine blade comprising, a hybrid fabric as described herein, or a composite article as described herein.

In a fifth aspect, the present invention provides the use of a texturized yarn to provide a carbon fiber and glass fiber hybrid fabric having an areal weight of less than about 500 g/m².

The invention includes the combination of the aspects and preferred features described herein except where such a combination is clearly impermissible or expressly avoided.

### BRIEF DESCRIPTION OF THE FIGURES

Embodiments and experiments illustrating the principles of the invention will now be discussed with reference to the accompanying figures in which:

FIG. 1 is a schematic diagram showing a fabric according to an embodiment of the invention;

FIG. 2 is an expanded view of section A shown in FIG. 1;

FIG. 3a is a photograph of the fabric formed by Example 1;

FIG. 3b is a photograph of the fabric formed by Example 2;

FIG. 3c is a photograph of the fabric formed by Example 3; and

FIG. 4 is a schematic diagram of a cross-section through a texturized yarn.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

The term “glass fibers” is used herein to refer to a plurality of continuous glass filaments (the term “continuous” as used here is used to refer to a fiber/filament that has a length many times longer than its diameter, for example at least about 5000 times longer than its diameter, e.g. at least about 10 000 times longer than its diameter). The glass fibers used in the fabrics described herein may be provided as glass fiber strands (or tows). The glass fibers described herein (e.g. the glass fibers of the second and/or third fibers) may have a sizing on their surface, e.g. the second and/or third fibers may have a sizing applied on the glass fibers during formation of the fibers. The sizing can include components such as a film former, lubricant, coupling agent (to promote compatibility between the glass fibers and the resin used to form a composite article comprising the hybrid fabric described herein), etc. that facilitate formation of the glass fibers and/or use thereof in a matrix resin. In some embodiments, the glass fibers of first and/or third fibers include a polyester compatible sizing or an epoxy compatible sizing.

The term “glass fiber strand” or “glass fiber tow” as used herein, refers to a bundle of continuous glass filaments. In embodiments the glass fiber strands or tows are bundles of untwisted glass filaments.

In embodiments, glass fiber strands or glass fiber tows are provided from glass fiber direct rovings. Glass fiber direct rovings are made up of a bundle of continuous untwisted (i.e. substantially parallel, or parallel) glass filaments bonded (as the glass filaments are formed) into a single strand and wound onto a bobbin.

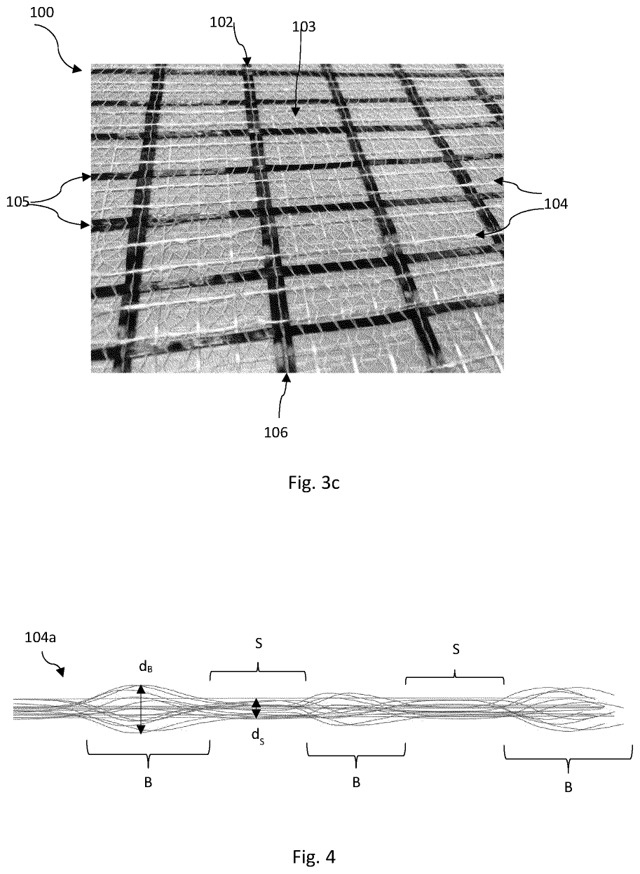

The term “texturized yarn” refers to a strand of fibers, e.g. glass fibers, comprising, consisting essentially of or consisting of a bundle of continuous filaments (for example, an unbonded bundle of continuous filaments) which have been texturized in a turbulent stream of compressed air. A schematic diagram of a cross-section through a “texturized yarn”, e.g. a texturized glass yarn, is shown in FIG. 4.

The term “texturized glass yarn” refers to a strand of glass fibers comprising, consisting essentially of or consisting of a bundle of continuous glass filaments (for example, an unbonded bundle of continuous glass filaments) which have been texturized in a turbulent stream of compressed air. The glass filaments forming a texturized glass yarn may be made from E glass, E-CR glass (such as Advantex™ glass), H glass, S glass, or AR glass types. An example of a suitable texturized glass yarn is ECT9 T140 K252C (available from Vetrotex™). A schematic diagram of a cross-section through a “texturized glass yarn” is shown in FIG. 4.

FIG. 4 shows a texturized yarn, e.g. a texturized glass yarn, 104a comprising bulked sections B, for example bulked sections B having a diameter dB. The bulked sections B of the texturized yarn are formed as a bundle of continuous filaments, e.g. glass filaments, (a strand of filaments, e.g. a strand of glass filaments) are passed through a turbulent stream of compressed air. The texturized yarn, e.g. texturized glass yarn, 104a shown in FIG. 4 shows bulked sections B having a diameter de interspersed with unbulked sections S having a diameter ds. Diameter ds may correspond to the minimum diameter of the texturized glass yarn. Diameter de may be a diameter at least 10% greater than the minimum diameter of the texturized yarn. Therefore, in embodiments, a “texturized yarn” (e.g. a texturized glass yarn) refers to a strand of fibers (e.g. a strand of glass fibers) comprising a plurality of bulked sections, for example the bulked sections being formed on exposure of the strand of fibers to a turbulent stream of compressed air. The diameter dB or ds may be determined by laying a strand of texturized yarn (e.g. a strand of texturized glass yarn) in a straight line on a flat surface with no tension applied to the texturized yarn, and measuring the diameter in a bulked or unbulked section respectively using, for example a measuring rule, by measuring the width of the texturized yarn perpendicular to the length of the texturized yarn. The minimum diameter may be taken to be the minimum diameter for a given length of the texturized yarn (e.g. the texturized glass yarn), for example the minimum diameter in a 10 cm length of the texturized yarn (e.g. the texturized glass yarn), or the minimum diameter of the texturized yarn (e.g. the texturized glass yarn) along the length of texturized yarn (e.g. texturized glass yarn) in the hybrid fabric.

The term “carbon fibers” is used herein to refer to a plurality of continuous carbon filaments (the term “continuous” as used here is used to refer to a fiber/filament that has a length many times longer than its diameter, for example at least about 5000 times longer than its diameter, e.g. at least about 10 000 times longer than its diameter). The carbon fibers used in the fabrics described herein may be provided as carbon fiber tows (or strands) which are bundles of continuous carbon filaments. The carbon fibers described herein (e.g. the carbon fibers of the first and/or fourth fibers) may have a sizing on their surface, e.g. the first and/or fourth fibers may have a sizing applied on the carbon fibers during formation of the fibers. The sizing can include components such as a film former, lubricant, coupling agent (to promote compatibility between the carbon fibers and the resin used to form a composite article comprising the hybrid fabric described herein), etc. that facilitate formation of the carbon fibers and/or use thereof in a matrix resin. In some embodiments, the carbon fibers of first and/or fourth fibers include a polyester compatible sizing or an epoxy compatible sizing.

The present invention provides a carbon fiber and glass fiber hybrid fabric comprising a first layer comprising first fibers oriented in a first direction and a second layer comprising second fibers oriented in a second direction. The hybrid fabric is a non-crimp fabric, the first and second fibers are maintained in their respective orientations with a stitching yarn (as opposed to the first and second fibers being woven together, i.e. a non-crimp fabric is a non-woven fabric). The second direction is within about 45 degrees to about 90 degrees of the first direction, for example, the second direction may be within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction. In embodiments, the second direction is substantially perpendicular to the first direction.

The first layer comprises first fibers oriented in a first direction, the first fibers comprise carbon fibers. In embodiments, the first layer comprises, consists essentially of, or consists of the first fibers. In embodiments, the first fibers comprise, consist essentially of, or consist of carbon fibers. In embodiments, the first fibers are carbon fibers.

In embodiments, the first layer comprises, consists essentially of, or consists of first fibers and third fibers, the first being oriented in a first direction and third fibers being oriented in a third direction. The third fibers may comprise glass fibers. In embodiments, the third fibers comprise, consist essentially of, or consist of glass fibers. In embodiments, the third fibers are glass fibers. In embodiments, the first layer comprises, consists essentially of, or consists of carbon fibers (first fibers) and glass fibers (third fibers). In embodiments the first direction and the third direction are the same direction (i.e. the third direction may be aligned with the first direction).

In embodiments, the first fibers, for example the carbon fibers oriented in the first direction, have a linear mass density in the range of about 100 Tex to about 5000 Tex, for example about 200 Tex to about 5000 Tex, about 400 Tex to about 5000 Tex, about 600 Tex to about 5000 Tex, about 800 Tex to about 5000 Tex, about 100 Tex to about 4800 Tex, about 200 Tex to about 4800 Tex, 400 Tex to about 4800 Tex, about 600 Tex to about 4800 Tex, about 800 Tex to about 4800 Tex, about 100 Tex to about 2400 Tex, about 200 Tex to about 2400 Tex, about 400 Tex to about 2400 Tex, about 100 Tex to about 2000 Tex, about 200 Tex to about 2000 Tex, about 400 Tex to about 2000 Tex, about 600 Tex to about 2000 Tex, about 800 Tex to about 2000 Tex, or about 1200 Tex.

In embodiments, the first fibers, for example the carbon fibers oriented in the first direction, have a diameter in the range of about 5 to about 15 μm, for example about 5 μm to about 11 μm.

In embodiments, the first layer comprises a plurality of first fiber strands. In embodiments, the first fiber strands are carbon fiber tows. In embodiments, the carbon fibers tows have a size in the range of 6K to 50K, for example 6K to 24K, or 6K to 12K. For example, the first fibers may be fed from one or more carbon fiber tows having a size in the range of 6K to 50K, for example 6K to 24K, or 6K to 12K. The nomenclature #K means that the carbon tow is made up of #×1,000 individual carbon filaments, i.e. a carbon fiber tow having a size of 6K is made up of approximately 6000 carbon fiber filaments/fibers.

In embodiments, the first layer comprises a plurality of first fiber strands, the first layer having a first fiber strand count in the range of about 0.25 to about 5 tows per cm, or about 0.25 to about 2.5 tows per cm. In embodiments, the first layer comprises a plurality of carbon fibers tows (for example a plurality of carbon fiber tows and each of the plurality of carbon fiber tows having a size in the range of 6K to 50K, for example, 6K to 24K, or 6K to 12K), the first layer having a carbon fiber tow count in the range of about 0.25 to about 5 tows per cm, or about 0.25 to about 2.5 tows per cm. The number of carbon fiber tows per cm is measured in a direction substantially perpendicular to the first direction, e.g. measured in the second direction.

In embodiments, the third fibers, for example the glass fibers (or glass fiber strands) oriented in the first direction, have a linear mass density in the range of about 50 Tex to about 5000 Tex, for example about 50 Tex to about 2000 Tex, about 50 Tex to about 1200 Tex, about 500 Tex to about 1200 Tex.

Any suitable glass reinforcing fibers may be employed as the third fibers, for example, fibers made from E glass, E-CR glass (such as Advantex™ glass), H glass, S glass, and AR glass types can be used. The glass fibers employed as the third fibers may have a diameter in the range of about 7 to about 25 μm, for example about 9 μm to about 17 μm.

The first fibers (e.g. the carbon fibers oriented in the first direction) may constitute at least about 15 wt. % of the fabric, for example at least about 20 wt. %, at least about 25 wt. %, at least about 30 wt. %, at least about 35 wt. %, at least about 40 wt. %, at least about 45 wt. %, or at least about 50 wt. % of the total weight of the fabric. In embodiments, the first fibers (e.g. the carbon fibers oriented in the first direction) constitute from about 15 wt. % to about 80 wt. % of the total weight of the fabric, for example from about 15 wt. % to about 70 wt. %, from about 15 wt. % to about 60 wt. %, from about 20 wt. % to about 75 wt. %, from about 25 wt. % to about 75 wt. %, from about 25 wt. % to about 70 wt. %, from about 25 wt. % to about 60 wt. %, from about 30 wt. % to about 75 wt. %, from about 30 wt. % to about 70 wt. %, from about 30 wt. % to about 60 wt. %, from about 35 wt. % to about 75 wt. %, from about 35 wt. % to about 70 wt. %, from about 35 wt. % to about 60 wt. %, from about 40 wt. % to about 75 wt. %, from about 40 wt. % to about 70 wt. %, from about 40 wt. % to about 60 wt. %, from about 50 wt. % to about 75 wt. %, from about 50 wt. % to about 70 wt. %, from about 50 wt. % to about 60 wt. % of the total weight of the fabric. In embodiments, the first fibers (e.g. the carbon fibers oriented in the first direction) may constitute from about 15 wt. % to about 80 wt. % of the fabric, for example from about 15 wt. % to about 70 wt. % of the fabric, from about 15 wt. % to about 60 wt. % of the fabric, from about 20 wt. % to about 75 wt. % of the fabric, from about 20 wt. % to about 70 wt. % of the fabric, from about 20 wt. % to about 60 wt. % of the fabric.

The third fibers (e.g. the glass fibers oriented in the third direction) may constitute up to about 70 wt. % of the total weight of the fabric, for example up to about 50 wt. %, up to about 40 wt. %, up to about 30 wt. %, or up to about 20 wt. % of the total weight of the fabric. In embodiments, the third fibers (e.g. the glass fibers oriented in the first direction) constitute from about 0 wt. % to about 70 wt. %, for example from about 2 wt. % to about 50 wt. %, from about 5 wt. % to about 30 wt. %, or from about 2 wt. % to about 20 wt. % of the total weight of the fabric.

In embodiments, the fibers of the first layer (e.g. the first fibers oriented in the first direction and, if present, the third fibers oriented in a third direction) constitute up to about 90 wt. % of the total weight of the fabric, for example up to about 85 wt. % of the fabric, or up to about 80 wt. % of the fabric. In embodiments, the fibers of the first layer (e.g. the first fibers and, if present, the third fibers) constitute from about 20 wt. % to about 90 wt. % of the total weight of the fabric, for example about 25 wt. % to about 85 wt. %, or about 25 wt. % to about 80 wt. % of the total weight of the fabric.

In embodiments, the first fibers, for example the carbon fibers (or carbon fiber tows) oriented in the first direction, in the fabric have an areal weight of less than about 200 g/m², for example less than about 150 g/m², less than about 100 g/m², less than about 90 g/m², or less than about 80 g/m². In embodiments, the first fibers, for example the carbon fibers (or carbon fiber tows) oriented in the first direction, in the fabric have an areal weight of at least about 10 g/m², for example at least about 20 g/m², at least about 30 g/m², at least about 40 g/m², at least about 50 g/m², at least about 60 g/m², at least about 70 g/m², or at least about 75 g/m². In embodiments, the first fibers, for example the carbon fibers (or carbon fiber tows) oriented in the first direction, in the fabric have an areal weight in the range of about 10 g/m² to about 200 g/m², for example about 20 g/m² to about 150 g/m², about 30 g/m² to about 100 g/m², about 50 g/m² to about 100 g/m², about 50 g/m² to about 80 g/m², about 50 g/m² to about 70 g/m², about 60 g/m² to about 70 g/m², about 10 g/m² to about 100 g/m², about 10 g/m² to about 80 g/m², about 10 g/m² to about 60 g/m², or about 10 g/m² to about 50 g/m².

In embodiments, the first layer comprises, consists essentially of, or consists of from about 50 wt. % to about 100 wt. % of the first fibers (e.g. carbon fibers) and from 0 wt. % to about 50 wt. % of the third fibers (e.g. glass fibers), for example from about 60 wt. % to about 100 wt. % of the first fibers (e.g. carbon fibers) and from 0 wt. % to about 40 wt. % of the third fibers (e.g. glass fibers), or from about 70 wt. % to about 100 wt. % of the first fibers (e.g. carbon fibers) and from 0 wt. % to about 30 wt. % of the third fibers (e.g. glass fibers). In embodiments, the first layer comprises, consists essentially of, or consists of from about 50 wt. % to about 95 wt. % of the first fibers (e.g. carbon fibers) and from 5 wt. % to about 50 wt. % of the third fibers (e.g. glass fibers), for example from about 60 wt. % to about 95 wt. % of the first fibers (e.g. carbon fibers) and from 5 wt. % to about 40 wt. % of the third fibers (e.g. glass fibers), or from about 70 wt. % to about 95 wt. % of the first fibers (e.g. carbon fibers) and from 5 wt. % to about 30 wt. % of the third fibers (e.g. glass fibers).

In embodiments, the first layer has an areal weight of at least about 20 wt. % of the total areal weight of the fabric, for example at least about 25 wt. % of the total areal weight of the fabric. In embodiments, the first layer has an areal weight of at least about 50 wt. % of the total areal weight of the fabric, or at least about 60 wt. % of the total areal weight of the fabric. In embodiments, the first layer has an areal weight in the range of about 20 wt. % to about 80 wt. % of the weight of the fabric, for example about 20 wt. % to about 70 wt. % of the weight of the fabric, or about 25 wt. % to about 60 wt. % of the weight of the fabric. The areal weight of the first layer of the fabric may be determined according to ISO 3374.

The second layer comprises second fibers oriented in a second direction, the second fibers are stabilization fibers. In embodiments, the second fibers comprise, consist essentially of, or consist of glass fibers (e.g. texturized glass yarn). In embodiments, the stabilization fibers comprise, consist essentially of, or consist of glass fibers (for example, texturized glass yarn). In embodiments, the second fibers comprise, consist essentially of, or consist of texturized yarn, for example texturized glass yarn. In embodiments, the second layer comprises, consists essentially of, or consists of the second fibers.

In embodiments, the second fibers/stabilization fibers may be any suitable glass reinforcing fibers, for example, fibers made from E glass, E-CR glass (such as Advantex™ glass), H glass, S glass, and AR glass types can be used. The glass fibers employed as the second fibers may have a diameter in the range of about 5 to about 25 μm, for example about 13 μm to about 24 μm.

In embodiments, the second fibers/stabilization fibers are a texturized yarn, for example a texturized yarn as described above (e.g. a texturized yarn as described above in relation to FIG. 4). In embodiments, the second fibers/stabilization fibers are a texturized glass yarn.

In embodiments, the carbon fiber and glass fiber hybrid fabric comprises a first layer comprising carbon fibers as the first fibers oriented in a first direction and a second layer comprising texturized glass yarn as the second fibers oriented in a second direction.

In embodiments, a “texturized yarn” refers to a strand of fibers comprising a plurality of bulked sections, for example the bulked sections being formed on exposure of the strand of fibers to a turbulent stream of compressed air. In embodiments, a bulked section of a texturized yarn (e.g. texturized glass yarn) is a section of the texturized yarn having a diameter at least 10% greater than, for example at least 15% greater than, at least 20% greater than, at least 30% greater than, at least 40% greater than, at least 50% greater than, at least 70% greater than, at least 80% greater than, at least 100% greater than, at least 150% greater than, or at least 200% greater than a minimum diameter of the texturized yarn (for example, with unbulked sections of the texturized yarn having a dimeter less than the lowest diameter of the bulked sections). The diameter of sections of the texturized yarn may be measured perpendicular to the yarn. A minimum diameter of the texturized yarn may be defined as the smallest diameter of the texturized yarn for a given section of the texturized fiber, for example the smallest diameter of the texturized yarn in a 10 cm length of the texturized yarn, or the smallest diameter of the texturized yarn along the length of texturized yarn in the hybrid fabric.

In embodiments, the texturized yarn (e.g. texturized glass yarn) has a minimum diameter of less than about 5 mm, for example, less than about 4 mm, less than about 3 mm, less than about 2 mm, or about 1 mm or less. In embodiments, the texturized yarn (e.g. texturized glass yarn) has a minimum diameter in the range of about 0.1 mm to about 5 mm, for example about 0.2 mm to about 4 mm, about 0.3 mm to about 3 mm, about 0.5 mm to about 2 mm, about 0.5 mm to about 1.5 mm, or about 0.7 mm to about 1.2 mm, or about 0.8 mm to about 1 mm.

In embodiments, a texturized yarn comprises a plurality of bulked sections, each bulked section having a diameter at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn. In embodiments, a texturized yarn comprises a plurality of bulked sections, each bulked section having a diameter in the range of 10% to 600%, 20% to 300%, or 20% to 250%, greater than the minimum diameter of the texturized yarn. In embodiments, a texturized yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and comprises 0.3 to 3 bulked sections per cm length of texturized yarn. In embodiments, a texturized yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and comprises about 2 to about 30, or about 2 to about 25 bulked sections per 10 cm length of texturized yarn. The number of bulked sections per 10 cm length of texturized yarn may be determined by laying a strand of texturized yarn (e.g. a strand of texturized glass yarn) in a straight line on a flat surface with no tension applied to the texturized yarn, and counting the number of bulked sections present in a 10 cm length of the texturized yarn wherein the bulked sections are as defined herein.

In embodiments, a texturized yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn, wherein the bulked sections of the texturized glass yarn constitute at least 10%, for example at least 20%, at least 25%, at least 30%, at least 35%, at least 40%, at least 45%, or at least 50% of the length of the texturized yarn.

In embodiments, a texturized yarn (e.g. texturized glass yarn) comprises at least about 2, for example at least about 3 or at least about 5 bulked sections (for example bulked sections as described herein) per 10 cm length of texturized yarn. In embodiments, a texturized yarn (e.g. texturized glass yarn) comprises up to about 30, for example up to about 25, up to about 20 or up to about 15 bulked sections (for example bulked sections as described herein) per 10 cm length of texturized yarn. In embodiments, a texturized yarn (e.g. texturized glass yarn) comprises from about 2 to about 30, for example about 2 to about 25, about 3 to about 20, or about 5 to about 15 bulked sections (for example bulked sections as described herein) per 10 cm length of texturized yarn. The number of bulked sections per 10 cm length of texturized yarn may be determined by laying a strand of texturized yarn (e.g. a strand of texturized glass yarn) in a straight line on a flat surface with no tension applied to the texturized yarn, and counting the number of bulked sections present in a 10 cm length of the texturized yarn wherein the bulked sections are as defined herein.

In embodiments, a texturized yarn (e.g. texturized glass yarn) comprises a plurality of bulked sections (for example bulked sections as described herein), successive bulked sections being spaced by a distance in the range of about 0.5 to about 80 mm, for example about 0.5 to about 50 mm, about 0.5 to about 10 mm, or about 2 to about 8 mm. The distance between successive bulked sections of texturized yarn may be determined by laying a strand of texturized yarn (e.g. a strand of texturized glass yarn) in a straight line on a flat surface with no tension applied to the texturized yarn and using a measuring rule to measure the distance between the end of one bulked section (for example where the diameter of the bulked section reduces to less than 110% of the minimum diameter of the texturized glass yarn) and the beginning of the next bulked section (for example where the diameter of the bulked section increases to 10% greater than the minimum diameter of the texturized glass yarn). In embodiments, the plurality of bulked sections of the texturized yarn are regularly distributed along the texturized yarn, for example the distance between successive bulked sections along the texturized yarn may be approximately the same (for example within about +10%, or within about +5%).

In embodiments, the texturized yarn (e.g. texturized glass yarn) comprises a plurality of bulked sections, each bulked section having a diameter in the range of 10% to 600%, 20% to 300%, or 20% to 250%, greater than the minimum diameter of the texturized yarn (e.g. the texturized glass yarn).

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn (e.g. the texturized glass yarn), and comprises about 2 to about 25 (for example about 5 to about 15) bulked sections per 10 cm length of texturized yarn.

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and the texturized yarn comprises about 2 to about 25 (for example about 5 to about 15) bulked sections per 10 cm length of texturized yarn.

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and the texturized yarn comprises about 2 to about 25 (for example about 5 to about 15) bulked sections per 10 cm length of texturized yarn, wherein successive bulked sections of texturized yarn are spaced by a distance in the range of about 0.5 to about 80 mm, for example about 0.5 to about 50 mm, about 0.5 to about 10 mm, or about 2 to about 8 mm. In embodiments, the bulked sections of the texturized yarn are regularly distributed along the texturized yarn

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, wherein the bulked sections of the texturized yarn constitute at least 10%, for example at least 20%, at least 25%, at least 30%, at least 35%, at least 40%, at least 45%, or at least 50% of the length of the texturized yarn.

In embodiments, the texturized yarn is a texturized glass yarn, i.e. a strand of glass fibers comprising a plurality of bulked sections, for example the bulked sections being formed on exposure of the strand of glass fibers to a turbulent stream of compressed air.

In embodiments, the second fibers/stabilization fibers are a texturized glass yarn, for example a texturized glass yarn as described above (e.g. a texturized glass yarn as described above in relation to FIG. 4). An example of a suitable texturized glass yarn is ECT9 T140 K252C (available from Vetrotex™). In embodiments, the texturized glass yarn comprises glass fibers having a diameter in the range of about 5 to about 25 μm, for example about 9 μm to about 24 μm. In embodiments, the texturized glass yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn. In embodiments, the texturized glass yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn, wherein the bulked sections of the texturized glass yarn constitute at least 10%, for example at least 20%, at least 25%, at least 30%, at least 35%, at least 40%, at least 45%, or at least 50% of the length of the texturized glass yarn.

In embodiments, the texturized glass yarn has a linear mass density in the range of about 30 Tex to about 500 Tex, for example about 50 Tex to about 300 Tex, about 68 Tex to about 280 Tex, about 70 Tex to about 300 Tex, or about 70 Tex to about 200 Tex.

In embodiments, the second fibers/stabilization fibers, for example the glass fibers (or glass fiber strands, e.g. texturized glass yarn) or texturized yarn oriented in the second direction, have a linear mass density in the range of about 30 Tex to about 500 Tex, for example about 50 Tex to about 300 Tex, about 68 Tex to about 280 Tex, about 70 Tex to about 300 Tex, or about 68 Tex to about 140 Tex.

In embodiments, the second layer comprises a plurality of second fiber strands (for example texturized glass yarn strands), the second layer having a second fiber strand count in the range of about 0.25 to about 5 tows per cm, or about 0.25 to about 2.5 tows per cm. In embodiments, the second layer comprises a plurality of glass fiber strands (for example a plurality of glass fiber strands and each of the plurality of glass fiber strands having a linear mass density in the range of about 30 Tex to about 500 Tex, for example about 50 Tex to about 300 Tex, about 68 Tex to about 280 Tex, about 70 Tex to about 300 Tex, or about 68 Tex to about 140 Tex), the second layer having a glass fiber strand count in the range of about 0.25 to about 5 strands per cm, or about 0.25 to about 2.5 strands per cm. The number of glass fiber strands per cm is measured in a direction substantially perpendicular to the second direction, e.g. measured in the first direction.

In embodiments, the second fibers/stabilization fibers, for example the glass fibers (or glass fiber strands, e.g. texturized glass yarn) or texturized yarn oriented in the second direction, in the fabric have an areal weight of less than about 100 g/m², for example less than about 75 g/m², less than about 50 g/m², less than about 40 g/m², or less than about 30 g/m². In embodiments, the second fibers, for example the glass fibers (or glass fiber strands, e.g. texturized glass yarn) oriented in the second direction, in the fabric have an areal weight of at least about 5 g/m², for example at least about 10 g/m², or at least about 20 g/m². In embodiments, the second fibers, for example the glass fibers (or glass fiber strands, e.g. texturized glass yarn) oriented in the second direction, in the fabric have an areal weight in the range of about 5 g/m² to about 100 g/m², for example about 5 g/m² to about 75 g/m², about 10 g/m² to about 50 g/m², about 10 g/m² to about 40 g/m², about 10 g/m² to about 30 g/m², about 20 g/m² to about 30 g/m², or about 5 g/m² to about 30 g/m².

In embodiments, the second layer comprises fourth fibers oriented in a fourth direction and/or fifth fibers oriented in a fifth direction. In embodiments, the fourth direction and/or fifth direction are aligned with the second direction. In embodiments, the fourth fibers and/or the fifth fibers (where present) are oriented in the second direction (i.e. the fourth direction and fifth direction are the same as the second direction). The fourth fibres may comprise or consist of fibers of materials other than glass, for example, the fourth fibers may comprise carbon fibers. The fifth fibres may comprise or consist of fibers of materials other than glass, for example, the fifth fibers may comprise polymer fibers (for example PET monofilaments). In embodiments, the fourth fibers comprise, consist essentially of, or consist of carbon fibers. In embodiments, the fourth fibers are carbon fibers. In embodiments, the fifth fibers comprise, consist essentially of, or consist of and/or polymer fibers (for example PET monofilaments). In embodiments, the second layer comprises, consists essentially of, or consists of the second fibers/stabilization fibers in combination with the fourth fibers and/or the fifth fibers. Examples of polymer fibers suitable for use as the fifth fibers include FILSTER 0.14 mm, FILSTER 0.25 mm and FILSTER 0.35 mm. In embodiments, the fifth fibers comprise, consist essentially of, or consist of polymer fibers having a diameter in the range of 0.05 mm to 0.5 mm.

In embodiments, the second layer comprises, consists essentially of, or consists of second fibers/stabilization fibers being texturized yarn (e.g. texturized glass yarn) and fourth fibers being carbon fibers. In embodiments, the second layer comprises, consists essentially of, or consists of second fibers/stabilization fibers being texturized yarn (e.g. texturized glass yarn), fourth fibers being carbon fibers and fifth fibers being polymer fibers (e.g. polymer monofilaments such as PET monofilaments).

In embodiments, the second fibers/stabilization fibers and the third fibers comprise glass fibers. In embodiments, the second fibers and the third fibers comprise glass fibers, wherein the second glass fibers differ from the third glass fibers.

In embodiments, the second fibers/stabilization fibers constitute less than about 50 wt. % of the total weight of the fabric, for example less than about 40 wt. %, less than about 35 wt. %, less than about 30 wt. %, or less than about 25 wt. % of the total weight of the fabric. In embodiments, the second fibers/stabilization fibers constitute from about 5 wt. % to about 50 wt. % of the total weight of the fabric, for example form about 10 wt. % to about 40 wt. %, or about 10 wt. % to about 30 wt. % of the total weight of the fabric.

In embodiments, the fourth fibers (e.g. the carbon fibers oriented in the fourth direction) may constitute at least about 15 wt. % of the total weight of the fabric, for example at least about 20 wt. %, at least about 25 wt. %, at least about 30 wt. %, at least about 35 wt. %, at least about 40 wt. %, at least about 45 wt. %, or at least about 50 wt. % of the total weight of the fabric. In embodiments, the fourth fibers (e.g. the carbon fibers oriented in the fourth direction) constitute from about 0 wt. % to about 80 wt. % of the total weight of the fabric, for example from about 15 wt. % to about 70 wt. %, from about 15 wt. % to about 60 wt. %, from about 20 wt. % to about 75 wt. %, from about 25 wt. % to about 75 wt. %, from about 25 wt. % to about 70 wt. %, from about 25 wt. % to about 60 wt. %, from about 30 wt. % to about 75 wt. %, from about 30 wt. % to about 70 wt. %, from about 30 wt. % to about 60 wt. %, from about 35 wt. % to about 75 wt. %, from about 35 wt. % to about 70 wt. % of the total weight of the fabric.

In embodiments, the fifth fibers (e.g. the polymer fibers oriented in the fifth direction) may constitute up to about 30 wt. % of the total weight of the fabric, for example up to about 20 wt. %, or up to about 10 wt. % of the total weight of the fabric. In embodiments, the fifth fibers (e.g. the polymer fibers oriented in the fifth direction) constitute from about 0 wt. % to about 30 wt. % of the total weight of the fabric, for example from about 0.5 wt. % to about 20 wt. %, or from about 1 wt. % to about 10 wt. % of the total weight of the fabric.

In embodiments, the second layer (e.g. the second fibers and, if present, the fourth and/or fifth fibers) constitute up to about 75 wt. % of the total weight of the fabric, for example up to about 70 wt. %, up to about 60 wt. %, up to about 50 wt. %, up to about 40 wt. %, or up to about 20 wt. % of the total weight of the fabric. In embodiments, the fibers oriented in the second direction (e.g. the second fibers and, if present, the fourth and/or fifth fibers) constitute from about 5 wt. % to about 50 wt. % of the total weight of the fabric, for example about 10 wt. % to about 40 wt. %, or about 10 wt. % to about 30 wt. % of the total weight of the fabric. In embodiments, the second layer (e.g. the second fibers and, if present, the fourth and/or fifth fibers) constitutes from about 5 wt. % to about 75 wt. % of the total weight of the fabric, for example about 10 wt. % to about 70 wt. %, or about 10 wt. % to about 60 wt. % of the total weight of the fabric.

In embodiments, the second layer comprises, consists essentially of, or consists of: from about 10 wt. % to about 100 wt. % of the second fibers (e.g. glass fibers and/or texturized yarn); from 0 wt. % to about 90 wt. % of the fourth fibers (e.g. carbon fibers); and from 0 wt. % to about 90 wt. % of the fifth fibers (e.g. polymer fibers) by total weight of the second layer. In embodiments, the second layer comprises, consists essentially of, or consists of: from about 15 wt. % to about 100 wt. % of the second fibers (e.g. glass fibers and/or texturized yarn); from 0 wt. % to about 85 wt. % of the fourth fibers (e.g. carbon fibers); and from 0 wt. % to about 70 wt. % of the fifth fibers (e.g. polymer fibers) by total weight of the second layer. In embodiments, the second layer comprises, consists essentially of, or consists of: from about 20 wt. % to about 100 wt. % of the second fibers (e.g. glass fibers and/or texturized yarn); from 0 wt. % to about 80 wt. % of the fourth fibers (e.g. carbon fibers); and from 0 wt. % to about 70 wt. % of the fifth fibers (e.g. polymer fibers) by total weight of the second layer. In embodiments, the second layer comprises, consists essentially of, or consists of: from about 25 wt. % to about 100 wt. % of the second fibers (e.g. glass fibers and/or texturized yarn); from 0 wt. % to about 75 wt. % of the fourth fibers (e.g. carbon fibers); and from 0 wt. % to about 70 wt. % of the fifth fibers (e.g. polymer fibers) by total weight of the second layer. In embodiments, the second layer comprises, consists essentially of, or consists of: from about 30 wt. % to about 100 wt. % of the second fibers (e.g. glass fibers and/or texturized yarn); from 0 wt. % to about 70 wt. % of the fourth fibers (e.g. carbon fibers); and from 0 wt. % to about 70 wt. % of the fifth fibers (e.g. polymer fibers) by total weight of the second layer. In embodiments, the second layer comprises, consists essentially of, or consists of: from about 50 wt. % to about 100 wt. % of the second fibers (e.g. glass fibers and/or texturized yarn); from 0 wt. % to about 50 wt. % of the fourth fibers (e.g. carbon fibers); and from 0 wt. % to about 50 wt. % of the fifth fibers (e.g. polymer fibers) by total weight of the second layer. In embodiments, the second layer comprises, consists essentially of, or consists of: from about 60 wt. % to about 100 wt. % of the second fibers (e.g. glass fibers and/or texturized yarn); from 0 wt. % to about 40 wt. % of the fourth fibers (e.g. carbon fibers); and from 0 wt. % to about 40 wt. % of the fifth fibers (e.g. polymer fibers) by total weight of the second layer. In embodiments, the second layer comprises, consists essentially of, or consists of: from about 70 wt. % to about 100 wt. % of the second fibers (e.g. glass fibers and/or texturized yarn); from 0 wt. % to about 30 wt. % of the fourth fibers (e.g. carbon fibers); and from 0 wt. % to about 30 wt. % of the fifth fibers (e.g. polymer fibers) by total weight of the second layer. In embodiments, the second layer comprises, consists essentially of, or consists of: from about 15 wt. % to about 100 wt. % of the second fibers (e.g. glass fibers and/or texturized yarn); from 0 wt. % to about 85 wt. % of the fourth fibers (e.g. carbon fibers); and from 0 wt. % to about 50 wt. % of the fifth fibers (e.g. polymer fibers) by total weight of the second layer. In embodiments, the second layer comprises, consists essentially of, or consists of: from about 15 wt. % to about 100 wt. % of the second fibers (e.g. glass fibers and/or texturized yarn); from 0 wt. % to about 85 wt. % of the fourth fibers (e.g. carbon fibers); and from 0 wt. % to about 30 wt. % of the fifth fibers (e.g. polymer fibers) by total weight of the second layer. In embodiments, the second layer comprises, consists essentially of, or consists of: from about 15 wt. % to about 80 wt. % of the second fibers (e.g. glass fibers and/or texturized yarn); from 20 wt. % to about 85 wt. % of the fourth fibers (e.g. carbon fibers); and from 0 wt. % to about 50 wt. % of the fifth fibers (e.g. polymer fibers) by total weight of the second layer. In embodiments, the second layer comprises, consists essentially of, or consists of: from about 20 wt. % to about 70 wt. % of the second fibers (e.g. glass fibers and/or texturized yarn); from 30 wt. % to about 80 wt. % of the fourth fibers (e.g. carbon fibers); and from 0 wt. % to about 30 wt. % of the fifth fibers (e.g. polymer fibers) by total weight of the second layer.

In embodiments, the hybrid fabric comprises: a first layer comprising, consisting essentially of, or consisting of from about 50 wt. % to about 100 wt. % of the first fibers (e.g. carbon fibers) and from 0 wt. % to about 50 wt. % of the third fibers (e.g. glass fibers) by total weight of the first layer; and a second layer comprising, consisting essentially of, or consisting of from about 10 wt. % to about 100 wt. % of the second fibers (e.g. glass fibers and/or texturized yarn); from 0 wt. % to about 90 wt. % of the fourth fibers (e.g. carbon fibers); and from 0 wt. % to about 90 wt. % of the fifth fibers (e.g. polymer fibers) by total weight of the second layer. In embodiments, the hybrid fabric comprises: a first layer comprising, consisting essentially of, or consisting of from about from about 60 wt. % to about 100 wt. % of the first fibers (e.g. carbon fibers) and from 0 wt. % to about 40 wt. % of the third fibers (e.g. glass fibers) by total weight of the first layer; and a second layer comprising, consisting essentially of, or consisting of from about 30 wt. % to about 100 wt. % of the second fibers (e.g. glass fibers and/or texturized yarn); from 0 wt. % to about 70 wt. % of the fourth fibers (e.g. carbon fibers); and from 0 wt. % to about 70 wt. % of the fifth fibers (e.g. polymer fibers) by total weight of the second layer. In embodiments, the hybrid fabric comprises: a first layer comprising, consisting essentially of, or consisting of from about 70 wt. % to about 100 wt. % of the first fibers (e.g. carbon fibers) and from 0 wt. % to about 30 wt. % of the third fibers (e.g. glass fibers) by total weight of the first layer; and a second layer comprising, consisting essentially of, or consisting of from about 50 wt. % to about 100 wt. % of the second fibers (e.g. glass fibers and/or texturized yarn); from 0 wt. % to about 50 wt. % of the fourth fibers (e.g. carbon fibers); and from 0 wt. % to about 50 wt. % of the fifth fibers (e.g. polymer fibers) by total weight of the second layer. In embodiments, the hybrid fabric comprises: a first layer comprising, consisting essentially of, or consisting of from about 50 wt. % to about 100 wt. % of the first fibers (e.g. carbon fibers) and from 0 wt. % to about 50 wt. % of the third fibers (e.g. glass fibers) by total weight of the first layer; and a second layer comprising, consisting essentially of, or consisting of from about 15 wt. % to about 100 wt. % of the second fibers (e.g. glass fibers); from 0 wt. % to about 85 wt. % of the fourth fibers (e.g. carbon fibers); and from 0 wt. % to about 70 wt. % of the fifth fibers (e.g. polymer fibers) by total weight of the second layer. In embodiments, the hybrid fabric comprises: a first layer comprising, consisting essentially of, or consisting of from about from about 60 wt. % to about 100 wt. % of the first fibers (e.g. carbon fibers) and from 0 wt. % to about 40 wt. % of the third fibers (e.g. glass fibers) by total weight of the first layer; and a second layer comprising, consisting essentially of, or consisting of from about 20 wt. % to about 100 wt. % of the second fibers (e.g. glass fibers); from 0 wt. % to about 80 wt. % of the fourth fibers (e.g. carbon fibers); and from 0 wt. % to about 70 wt. % of the fifth fibers (e.g. polymer fibers) by total weight of the second layer. In embodiments, the hybrid fabric comprises: a first layer comprising, consisting essentially of, or consisting of from about from about 60 wt. % to about 100 wt. % of the first fibers (e.g. carbon fibers) and from 0 wt. % to about 40 wt. % of the third fibers (e.g. glass fibers) by total weight of the first layer; and a second layer comprising, consisting essentially of, or consisting of from about 25 wt. % to about 100 wt. % of the second fibers (e.g. glass fibers); from 0 wt. % to about 75 wt. % of the fourth fibers (e.g. carbon fibers); and from 0 wt. % to about 70 wt. % of the fifth fibers (e.g. polymer fibers) by total weight of the second layer. In embodiments, the hybrid fabric comprises: a first layer comprising, consisting essentially of, or consisting of from about from about 60 wt. % to about 100 wt. % of the first fibers (e.g. carbon fibers) and from 0 wt. % to about 40 wt. % of the third fibers (e.g. glass fibers) by total weight of the first layer; and a second layer comprising, consisting essentially of, or consisting of from about 15 wt. % to about 80 wt. % of the second fibers (e.g. glass fibers); from 20 wt. % to about 85 wt. % of the fourth fibers (e.g. carbon fibers); and from 0 wt. % to about 50 wt. % of the fifth fibers (e.g. polymer fibers) by total weight of the second layer. In each of these embodiments, the second fibers may be provided by a texturized glass yarn as described herein. In each of these embodiments, the areal weight of the fabric may be less than about 400 g/m², less than about 300 g/m², less than about 200 g/m², or less than about 150 g/m².

In embodiments, the second layer has an areal weight of up to about 75 wt. % of the total areal weight of the fabric, for example up to about 70 wt. % of the total areal weight of the fabric, up to about 60 wt. % of the total areal weight of the fabric, up to about 50 wt. % of the total areal weight of the fabric, up to about 40 wt. %, or up to about 30 wt. % of the total areal weight of the fabric. In embodiments, the second layer has an areal weight in the range of about 5 wt. % to about 75 wt. % of the weight of the fabric, for example about 10 wt. % to about 70 wt. %, about 20 wt. % to about 70 wt. %, about 25 wt. % to about 70 wt. %, about 5 wt. % to about 50 wt. %, about 5 wt. % to about 40 wt. %, about 10 wt. % to about 30 wt. %, about 20 wt. % to about 40 wt. %, about 20 wt. % to about 30 wt. % of the weight of the fabric. The areal weight of the second layer of the fabric may be determined according to ISO 3374.

In embodiments, the stitching yarn constitutes less than about 25 wt. % of the total weight of the fabric, for example, less than about 15 wt. %, less than about 10 wt. %, or less than about 8 wt. % of the total weight of the fabric. In embodiments, the stitching yarn constitutes from about 0.5 wt. % to about 25 wt. % of the total weight of the fabric, for example about 0.5 wt. % to about 15 wt. %, from about 1 wt. % to about 10 wt. %, or from about 2 wt. % to about 8 wt. % of the total weight of the fabric.

Any suitable stitching yarn may be employed. In embodiments, the stitching yarn is a polyester yarn. In embodiments, the stitching yarn has a linear mass density in the range of about 50 dTex to about 300 dTex.

In embodiments, the stitching yarn forms a stitching pattern through the fabric, the stitching pattern may be selected from a tricot stitching pattern, a symmetric double tricot stitching pattern, an asymmetric double tricot stitching pattern, a symmetric diamant stitching pattern, and an asymmetric diamant stitching pattern. In embodiments, the stitching yarn forms a stitching pattern through the fabric, the stitching pattern being a tricot stitching pattern

In embodiments, the stitching yarn defines a stitching length, the stitching length being in the range of about 2 mm to about 7 mm, for example about 3 mm.

The hybrid fabric described herein may have an areal weight of less than about 1000 g/m², for example less than about 500 g/m², less than about 400 g/m², less than about 300 g/m², less than about 200 g/m², or less than about 150 g/m². In embodiments, the hybrid fabric has an areal weight in the range of about 50 g/m² to about 500 g/m², for example about 50 g/m² to about 400 g/m², about 50 g/m² to about 200 g/m², or about 100 g/m² to about 200 g/m². The areal weight of the fabric may be determined according to ISO 3374.

In the carbon fiber and glass fiber hybrid fabric described herein, at least one of the first and second layers comprises glass fibers. In embodiments, the glass fibers of the hybrid fabric are provided at least one of the second fibers or the third fibers described herein. In embodiments, the first layer comprises third fibers oriented in a third direction, the third fibers being glass fibers; and/or or the stabilization fibers are texturized glass yarn.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 45 degrees to about 90 degrees of the first direction,

the first fibers are carbon fibers,

the second fibers are stabilization fibers,

the areal weight of the fabric is less than about 500 g/m²

the first fibers constitute at least about 15 wt. % of the total weight of the fabric,

the second fibers constitute less than about 50 wt. % of the total weight of the fabric,

wherein: the first layer further comprises third fibers oriented in a third direction, the third fibers being glass fibers; and/or or the stabilization fibers are texturized glass yarn.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 45 degrees to about 90 degrees of the first direction,

the first fibers are carbon fibers,

the second fibers are stabilization fibers,

the areal weight of the fabric is less than about 500 g/m²

the first fibers constitute at least about 20 wt. % of the total weight of the fabric,

the second fibers constitute less than about 50 wt. % of the total weight of the fabric.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 45 degrees to about 90 degrees of the first direction,

the first fibers are carbon fibers,

the second fibers are stabilization fibers,

the areal weight of the fabric is less than about 500 g/m²

the first fibers constitute at least about 25 wt. % of the total weight of the fabric, and

the second fibers constitute less than about 50 wt. % of the total weight of the fabric.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the areal weight of the fabric is less than about 500 g/m²

the first fibers constitute at least about 15 wt. % of the total weight of the fabric,

the second fibers constitute less than about 50 wt. % of the total weight of the fabric, and

the first layer constitutes at least about 25 wt. % of the total weight of the fabric.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the areal weight of the fabric is less than about 500 g/m²

the first fibers constitute at least about 25 wt. % of the total weight of the fabric,

the second fibers constitute less than about 50 wt. % of the total weight of the fabric, and

the first layer constitutes at least about 50 wt. % of the total weight of the fabric.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the areal weight of the fabric is less than about 400 g/m²

the first fibers constitute at least about 20 wt. % of the total weight of the fabric,

the second fibers constitute less than about 50 wt. % of the total weight of the fabric, and the first layer constitutes at least about 25 wt. % of the total weight of the fabric.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the areal weight of the fabric is less than about 400 g/m²

the first fibers constitute at least about 25 wt. % of the total weight of the fabric,

the second fibers constitute less than about 50 wt. % of the total weight of the fabric, and

the first layer constitutes at least about 50 wt. % of the total weight of the fabric.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the areal weight of the fabric is less than about 500 g/m²

the first fibers constitute at least about 20 wt. % of the total weight of the fabric,

the second fibers constitute less than about 50 wt. % of the total weight of the fabric, and

the first layer constitutes at least about 25 wt. % of the total weight of the fabric,
wherein the texturized glass yarn comprises a plurality of bulked sections, each bulked section having a diameter of at least 10% greater than a minimum diameter of the texturized glass yarn, optionally wherein the bulked sections of the texturized glass yarn constitute at least 10% of the length of the texturized glass yarn.

In embodiments, the carbon fiber and glass fiber hybrid fabric comprises:
a first layer comprising first fibers oriented in a first direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers texturized glass yarn,

the areal weight of the fabric is less than about 500 g/m²

the first fibers constitute at least about 25 wt. % of the total weight of the fabric,

the second fibers constitute less than about 50 wt. % of the total weight of the fabric, and

the first layer constitutes at least about 50 wt. % of the total weight of the fabric,
wherein the texturized glass yarn comprises a plurality of bulked sections, each bulked section having a diameter of at least 10% greater than a minimum diameter of the texturized glass yarn, optionally wherein the bulked sections of the texturized glass yarn constitute at least 10% of the length of the texturized glass yarn.

In embodiments, the carbon fiber and glass fiber hybrid fabric comprises:
a first layer comprising first fibers oriented in a first direction and third fibers oriented in a third direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the third fibers are glass fibers,

the areal weight of the fabric is less than about 500 g/m²

the first fibers constitute at least about 25 wt. % of the total weight of the fabric,

the second fibers constitute less than about 50 wt. % of the total weight of the fabric, and

the first layer constitutes at least about 50 wt. % of the total weight of the fabric.

In embodiments, the carbon fiber and glass fiber hybrid fabric comprises:
a first layer comprising first fibers oriented in a first direction and third fibers oriented in a third direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the third fibers are glass fibers,

the areal weight of the fabric is less than about 500 g/m²

the first fibers constitute at least about 40 wt. % of the total weight of the fabric,

the second fibers constitute less than about 50 wt. % of the total weight of the fabric, and

the first layer constitutes at least about 60 wt. % of the total weight of the fabric.

In embodiments, the carbon fiber and glass fiber hybrid fabric comprises:
a first layer comprising first fibers oriented in a first direction and third fibers oriented in a third direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the third fibers are glass fibers,

the areal weight of the fabric is less than about 400 g/m²

the first fibers constitute at least about 20 wt. % of the total weight of the fabric,

the second fibers constitute less than about 50 wt. % of the total weight of the fabric, and

the first layer constitutes at least about 25 wt. % of the total weight of the fabric,

wherein the texturized glass yarn comprises a plurality of bulked sections, each bulked section having a diameter of at least 10% greater than a minimum diameter of the texturized glass yarn, optionally wherein the bulked sections of the texturized glass yarn constitute at least 20% of the length of the texturized glass yarn.

In embodiments, the carbon fiber and glass fiber hybrid fabric comprises:
a first layer comprising first fibers oriented in a first direction and third fibers oriented in a third direction;
a second layer comprising second fibers oriented in a second direction;
a stitching yarn maintaining the fibers of the first and second layers in their respective orientations,

wherein the second direction is within about 80 degrees to about 90 degrees of the first direction,

the first fibers are carbon fibers,

the second fibers are texturized glass yarn,

the third fibers are glass fibers,

the areal weight of the fabric is less than about 400 g/m²

the first fibers constitute at least about 40 wt. % of the total weight of the fabric,

the second fibers constitute less than about 50 wt. % of the total weight of the fabric, and

the first layer constitutes at least about 60 wt. % of the total weight of the fabric,

wherein the texturized glass yarn comprises a plurality of bulked sections, each bulked section having a diameter of at least 10% greater than a minimum diameter of the texturized glass yarn, optionally wherein the bulked sections of the texturized glass yarn constitute at least 20% of the length of the texturized glass yarn.

In embodiments, the carbon fiber and glass fiber hybrid fabric comprises:
a first layer comprising first fibers oriented in a first direction;
a second layer comprising second fibers oriented in a second direction and fourth fibers oriented in a fourth direction.
a stitching yarn maintaining the fibers of the first and second layers in their respective orientations,

wherein the second direction is within about 45 degrees to about 90 degrees (optionally about 80 degrees to about 90 degrees) of the first direction,

the first fibers are carbon fibers,

the second fibers are texturized glass yarn,

the fourth fibers are carbon fibers,

the areal weight of the fabric is less than about 400 g/m²

the first fibers constitute at least about 15 wt. % of the total weight of the fabric,

the second fibers constitute less than about 50 wt. % of the total weight of the fabric, and

the fourth fibers constitute at least about 10 wt. % of the total weight of the fabric.

In embodiments, the carbon fiber and glass fiber hybrid fabric comprises:
a first layer comprising first fibers oriented in a first direction and third fibers oriented in a third direction;
a second layer comprising second fibers oriented in a second direction and fourth fibers oriented in a fourth direction.
a stitching yarn maintaining the fibers of the first and second layers in their respective orientations,

wherein the second direction is within about 45 degrees to about 90 degrees (optionally about 80 degrees to about 90 degrees) of the first direction,

the first fibers are carbon fibers,

the second fibers are texturized glass yarn,

the third fibers are glass fibers,

the fourth fibers are carbon fibers,

the areal weight of the fabric is less than about 400 g/m²

the first fibers constitute at least about 15 wt. % of the total weight of the fabric,

the second fibers constitute less than about 50 wt. % of the total weight of the fabric, and

the fourth fibers constitute at least about 10 wt. % of the total weight of the fabric.

In embodiments, the carbon fiber and glass fiber hybrid fabric comprises:
a first layer comprising first fibers oriented in a first direction;
a second layer comprising second fibers oriented in a second direction and fourth fibers oriented in a fourth direction.
a stitching yarn maintaining the fibers of the first and second layers in their respective orientations,

wherein the second direction is within about 45 degrees to about 90 degrees (optionally about 80 degrees to about 90 degrees) of the first direction,

the first fibers are carbon fibers,

the second fibers are texturized glass yarn,

the fourth fibers are carbon fibers,

the areal weight of the fabric is less than about 400 g/m²

the first fibers constitute at least about 20 wt. % of the total weight of the fabric,

the second fibers constitute less than about 30 wt. % of the total weight of the fabric, and

the fourth fibers constitute at least about 20 wt. % of the total weight of the fabric.

In embodiments, the carbon fiber and glass fiber hybrid fabric comprises:
a first layer comprising first fibers oriented in a first direction and third fibers oriented in a third direction;
a second layer comprising second fibers oriented in a second direction and fourth fibers oriented in a fourth direction.
a stitching yarn maintaining the fibers of the first and second layers in their respective orientations,

wherein the second direction is within about 45 degrees to about 90 degrees (optionally about 80 degrees to about 90 degrees) of the first direction,

the first fibers are carbon fibers,

the second fibers are texturized glass yarn,

the third fibers are glass fibers,

the fourth fibers are carbon fibers,

the areal weight of the fabric is less than about 400 g/m²

the first fibers constitute at least about 20 wt. % of the total weight of the fabric,

the second fibers constitute less than about 30 wt. % of the total weight of the fabric, and

the fourth fibers constitute at least about 20 wt. % of the total weight of the fabric.

In general, the hybrid fabric contains no resin, i.e., none of the fibers forming the fabric are pre-impregnated with a resin.

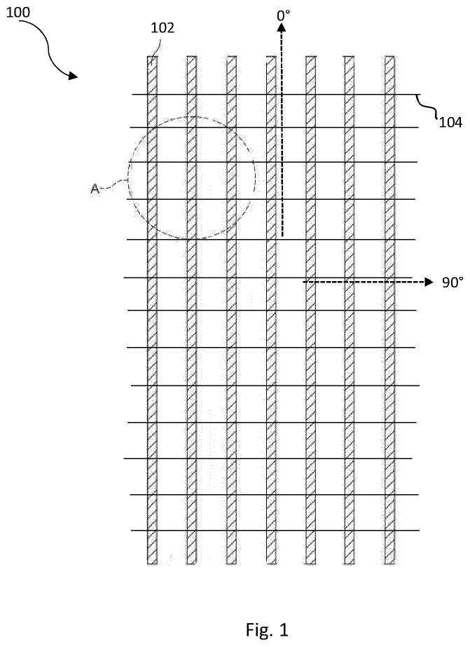

FIG. 1 is a schematic diagram of a hybrid reinforcement fabric 100 which is constructed from first fibers 102 (e.g. carbon fiber tows) and second fibers (e.g. glass fibers) 104. The first fibers 102 are oriented in a first direction (0° direction which is aligned with the length of the fabric) and the second fibers are oriented in a second direction which is substantially perpendicular to the first direction (90° direction shown in FIG. 1).

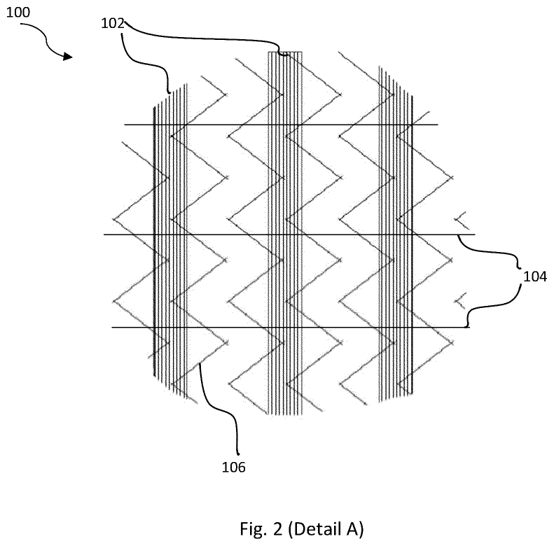

FIG. 2 shows an expanded view of section “A” from FIG. 1. FIG. 2 shows the stitching yarn 106 which forms a stitching pattern through the fabric 100 to maintain the first fibers 102 and the second fibers 104 in their respective orientations.

The first fibers may be arranged in the first layer such there is a gap between adjacent first fibers (for example a gap between adjacent carbon fiber tows) 102.

In embodiments, the stitching yarn forms a stitching pattern comprising stiches along at least one of the strands of first fibers 102, for example along each of the plurality of first fiber strands (e.g. along each of the plurality of carbon fiber tows).

In embodiments, the stitching yarn forms stiches in a gap between adjacent strands of first fibers 102, for example between adjacent carbon fiber tows.

In embodiments, the first layer may comprise between about 0.25 and about 5 first fiber strands (e.g. carbon fiber tows) 102 per cm (as measured perpendicular to the first direction, for example as measured along the second direction), or about 0.25 to about 2.5 tows per cm.

In embodiments, the first layer may comprise between about 0.25 and about 5 third fiber strands (e.g. glass fiber strands) per cm (as measured perpendicular to the first direction, for example as measured along the second direction), or about 0.25 to about 2.5 tows per cm.

In embodiments, the second layer comprises between about 0.25 and about 5 second fiber strands (e.g. glass fiber strands) per cm (as measured perpendicular to the second direction, for example as measured along the first direction), or about 0.25 to about 2.5 strands per cm.

In embodiments, the second layer comprises between about 0.25 and about 5 fourth fiber strands (e.g. carbon fiber tows) per cm (as measured perpendicular to the second direction, for example as measured along the first direction), or about 0.25 to about 2.5 strands per cm.

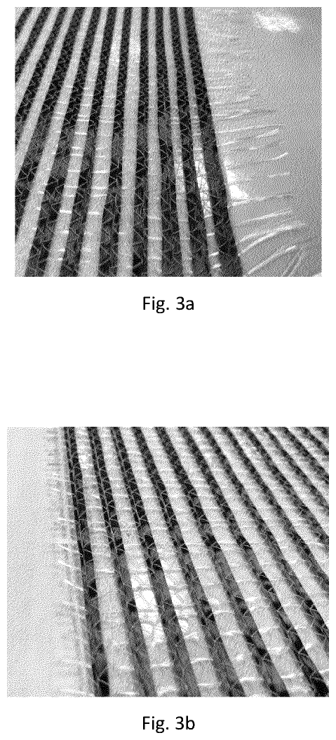

FIG. 3c is a photograph of a hybrid reinforcement fabric 100 (as provided in Example 3 below) which comprises a first layer containing first fibers 102 (e.g. carbon fiber tows) and third fibers 103 (e.g. glass fibers); and a second layer comprising second fibers (e.g. glass fibers) 104 and fourth fibers (e.g. carbon fibers) 105. The first fibers 102 are oriented in a first direction (0° direction which is aligned with the length of the fabric) and the second fibers are oriented in a second direction which is substantially perpendicular to the first direction. The third fibers 103 are oriented in a third direction which is aligned with the first direction and the fourth fibers 105 are oriented in a fourth direction which is aligned with the second direction.

The first fibers and third may be arranged in the first layer such there is a gap between adjacent first and third fibers 102, 103 (for example a gap between adjacent carbon fiber tows and a gap between adjacent glass fiber strands as well as a gap between adjacent carbon fiber tows and glass fiber strands). The fibers of the second layer, for example the second and fourth fibers 104, 105, may be arranged such there is a gap between adjacent fibers of the second layer (for example a gap between adjacent carbon fiber tows and a gap between adjacent glass fiber strands (e.g. texturized glass yarn) as well as a gap between adjacent carbon fiber tows and glass fiber strands (e.g. texturized glass yarn)).

In embodiments, the hybrid fabric described herein may be impregnated with a resin and the resin cured to form a composite article.

### EXAMPLES

The following illustrates examples of the fabrics and related aspects described herein. Thus, these examples should not be considered to restrict the present disclosure, but are merely in place to teach how to carry out the processes and obtain the products of the present disclosure.

### Example 1

A hybrid fabric was produced by providing a first layer containing carbon fibers and glass fibers orientated in the 0° direction (i.e. along the length of the fabric), a second layer made up of glass fibres orientated in the 90° direction (i.e. perpendicular to the length of the fabric).

The first layer was formed by providing strands of 12K carbon fiber, each carbon fiber strand having a linear density of about 800 Tex (the filaments of the carbon fibers having a diameter of 7 μm and an epoxy resin compatible sizing) and 2 strands of 1200 Tex glass fibres fed from a direct roving (Advantex™ E-CR glass fibers with an epoxy resin compatible sizing, the filaments of the glass fibers having a diameter of 17 μm), the strands of carbon fibers were aligned in the 0° direction and equally spaced over the fabric width, the two glass fiber strands were placed at either end of the carbon fiber strands. The carbon fiber strands in the first layer were present at 0.98 strands per cm.

The second layer was formed by providing 68 Tex glass fiber strands (E-glass with an epoxy resin compatible sizing) orientated at 90° to the first fibers of the first layer with the second layer comprising 1.97 glass fibers strands per cm (measured perpendicular to the second direction, i.e. along the first direction). The fringes of the fabric formed by the glass fiber strands of the second layer were cut on the machine around 5 mm.

The first and second layers were stitched together using a polyester stitching yarn having a linear density of 7.6 Tex employing a tricot stitching pattern with a stich length of 3 mm. The fabrics were stitched such that the stitching yarn 106 formed stiches along each of the carbon fiber strands (tows) 102 and also within each of the gaps between adjacent carbon fiber tows as schematically shown in FIG. 2.

The overall areal weight of the fabric was 127 g/m².

FIG. 3a shows a photograph of the fabric of Example 1. The photograph of FIG. 3a shows that the fabric of Example 1 showed some shrinking, the shrinking caused an increase in the fringe length.

### Example 2

A hybrid fabric was produced as described in Example 1 except that the second layer was formed by providing 140 Tex texturized glass yarn (texturized E-glass yarn ECT9 T140 K252C from Vetrotex™) orientated at 90° to the first fibers of the first layer with about 5 mm between adjacent glass fiber strands of the second layer. The texturized glass yarn used had a minimum diameter of 0.9 mm, with 1.2 bulked sections per cm (each bulked section determined as a length of yarn having a diameter, ds, (measured perpendicular to the length of the yarn, for example as shown in FIG. 4) of at least 10% greater than the minimum diameter of the yarn (i.e. greater than 1 mm)). The texturized glass yarn used comprised 1.2 bulked sections per cm and the bulked sections of the texturized glass yarn constituted more than 50% of the length of the texturized glass yarn. The fringes of the fabric formed by the glass fiber strands of the second layer were around 3 mm (smaller fringes possible due to improved product stability and shrinkage reduction). The fabric had a thickness of 0.45 mm. The improved stability of the hybrid fabric of example 2 compared to the hybrid fabric of example 1 can be observed from FIGS. 3a and 3b which show the more even spacing of the carbon tows in the fabric of example 2, along with the smaller fringes, compared to the fabric of example 1 provided after stitching due to the use of the texturized glass yarn in example 2.

Employing the texturized glass fibers (texturized glass yarn) in the 90° direction provided a lightweight product with excellent stability and resistance to handling.

FIG. 3b shows a photograph of the fabric of Example 2.

### Example 3

A hybrid fabric was produced by providing a first layer containing carbon fibers (first fibers) and glass fibers (third fibers) orientated in the 0° direction (i.e. along the length of the fabric), a second layer made up of texturized glass yarn (second fibers), carbon fibers (fourth fibers) and PET monofilaments (fifth fibers) orientated in the 90° direction (i.e. perpendicular to the length of the fabric).

The first layer was formed by providing strands of 12K carbon fiber, each carbon fiber strand having a linear density of about 800 Tex (the filaments of the carbon fibers having a diameter of 7 μm and an epoxy resin compatible sizing) and strands of 68 Tex glass fibres fed from a direct roving (Advantex™ E-CR glass fibers with an epoxy resin compatible sizing, the filaments of the glass fibers having a diameter of 9 μm), the strands of carbon fibers and glass fibers were aligned in the 0° direction and evenly spaced over the fabric width, with 0.25 strands of the carbon fiber per cm and 0.74 strands of glass fiber strands per cm.

The second layer was formed by providing 140 Tex texturized glass yarn (texturized E-glass yarn ECT9 T140 K252C from Vetrotex™) orientated at 90° to the first fibers of the first layer with about 0.87 strands of texturized glass yarn per cm, the strands of texturized glass yarn equally spaced over the length of the fabric. The texturized glass yarn used had a minimum diameter of 0.9 mm, with 12 bulked sections per 10 cm (each bulked section determined as a length of yarn having a diameter, ds, (measured perpendicular to the length of the yarn, for example as shown in FIG. 4) of at least 10% greater than the minimum diameter of the yarn (i.e. greater than 1 mm)). The texturized glass yarn used comprised 12 bulked sections per 10 cm and the bulked sections of the texturized glass yarn constituted more than 50% of the length of the texturized glass yarn. The second layer also contained strands of 12K carbon fiber aligned with the texturized glass yarn, each carbon fiber strand having a linear density of about 800 Tex (the filaments of the carbon fibers having a diameter of 7 μm and an epoxy resin compatible sizing) with 0.43 strands of carbon fiber per cm across the length of the fabric; and PET monofilaments, aligned with the texturized yarn, having a diameter of 15 μm, a linear density of 24.3 Tex, and with 0.87 PET monofilaments per cm across the length of the fabric. The carbon fibers, texturized glass yarn and PET monofilaments were evenly spaced over the length of the fabric.

The first and second layers were stitched together using a polyester stitching yarn having a linear density of 7.6 Tex employing a tricot stitching pattern with a stich length of 3 mm. The fabrics were stitched such that the stitching yarn 106 formed stiches along each of the carbon fiber strands (tows) 102 and also within each of the gaps between adjacent carbon fiber tows as schematically shown in FIG. 2.

The overall areal weight of the fabric was 85 g/m².

The fringes of the fabric formed by the glass fiber strands of the second layer were less than 5 mm (smaller fringes possible due to improved product stability and shrinkage reduction).

FIG. 3c shows a photograph of the fabric of Example 3.

Table 1 below provides a summary of the fabrics produced according to Examples 1 to 3.

TABLE 1

| | Areal | Areal | | Areal | Areal | | | |
|---|---|---|---|---|---|---|---|---|
| | weight of | weight of | | weight of | weight of | Areal weight | Areal | |
| | first (0°) | third (0°) | | second | fourth (90°) | of fifth | weight of | |
| | carbon | glass | Second | (90°) glass | carbon | (90°) PET | stitching | Fabric total |
| | fibers | fibers | fibers | fibers | fibers | monofilaments | yarn | areal weight |
| Fabric | (g/m²) | (g/m²) | (90°) | (g/m²) | (g/m²) | (g/m²) | (g/m²) | (g/m²) |
| Ex. 1 | 78 | 11 | 68 Tex | 28 | — | — | 10 | 127 |
| | | | (direct | | | | | |
| | | | roving) | | | | | |
| Ex. 2 | 78 | 21 | Texturized | 28 | — | — | 10 | 137 |
| | | | glass yarn | | | | | |
| | | | 140 Tex | | | | | |
| Ex. 3 | 21 | 5 | Texturized | 12 | 35 | 2 | 10 | 85 |
| | | | glass yarn | | | | | |
| | | | 140 Tex | | | | | |

The areal weight of the different components and of the fabrics was determined according to ISO 3374.

The hybrid fabrics of the examples were also found to be readily infused at an acceptable infusion speed, without requiring that the carbon fibers (e.g. the carbon fiber tows) used to form the hybrid fabric be spread or pre-impregnated with resin.

The present inventors have surprisingly found that by providing a hybrid fabric comprising carbon fibers in a first direction and a texturized yarn in a second direction, the stability and resistance to handling of the lightweight hybrid fabric is improved compared to hybrid fabrics comprising standard fibers (e.g. standard glass fibers), as opposed to texturized yarn, in the second direction.

Conventionally, a skilled person aiming to provide a non-crimp fabric would choose fibers and fiber position in order to optimise fiber alignment which would be expected to optimise mechanical properties of the non-crimp fabric. Therefore, the use of a texturized yarn in a non-crimp fabric, such as the hybrid fabrics described herein, goes against the skilled person's understanding of how non-crimp fabrics should be produced (the fibers in a texturized yarn are not all aligned (see, for example, FIG. 4), this non-alignment of the fibers in a texturized yarn allows for the required bulk of the texturized yarn). It is even more surprising that the use of a texturized yarn in the hybrid fabrics described herein actually improves the stability and resistance to handling of the hybrid fabrics.

The Examples provided herein demonstrate that using texturized yarn as described herein allows the provision of very lightweight carbon fiber and glass fiber hybrid fabrics by improving the stability of the fabrics which may contain carbon fibers oriented in a single direction or carbon fibers oriented in different directions.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

1. A carbon fiber and glass fiber hybrid fabric comprising:
a first layer comprising a plurality of first fibers oriented in a first direction;
a second layer comprising a plurality of second fibers oriented in a second direction;
a stitching yarn maintaining the fibers of the first and second layers in their respective orientations,
wherein the second direction is within about 45 degrees to about 90 degrees of the first direction,
wherein the first fibers comprise carbon fibers,
wherein the second fibers are stabilization fibers,
wherein an areal weight of the fabric is less than about 500 g/m²,
wherein the first fibers constitute at least about 15 wt. % of the hybrid fabric, and wherein the second fibers constitute less than about 50 wt. % of the hybrid fabric.

2. The hybrid fabric according to claim 1, wherein the areal weight of the fabric is less than about 200 g/m².

3. The hybrid fabric according to claim 1, wherein the stabilization fibers are a texturized yarn.

4. The hybrid fabric according to claim 3, wherein the texturized yarn is a texturized glass yarn.

5. The hybrid fabric according to claim 3, wherein the texturized yarn has a minimum diameter of less than about 4 mm.

6. The hybrid fabric according to claim 3, wherein the texturized yarn comprises a plurality of bulked sections, each bulked section having a diameter of at least 10% greater than a minimum diameter of the texturized yarn.

7. The hybrid fabric according to claim 6, wherein the bulked sections of the texturized yarn constitute at least 10% of a length of the texturized yarn.

8. The hybrid fabric according to claim 6, wherein the texturized yarn comprises about 2 to about 30 bulked sections per 10 cm length of the texturized yarn.

9. The hybrid fabric according to claim 3, wherein the texturized yarn oriented in the second direction constitutes from about 5 wt. % to about 30 wt. % of the hybrid fabric.

10. The hybrid fabric according to claim 1, wherein the first layer further comprises a plurality of third fibers oriented in a third direction, the third fibers being glass fibers.

11. The hybrid fabric according to claim 1, wherein the first layer comprises between about 0.25 and about 5 of the first fibers per cm.

12. The hybrid fabric according to claim 1, wherein the stitching yarn forms stiches along a plurality of the first fibers.

13. The hybrid fabric according to claim 1, wherein the second layer comprises between about 0.25 and about 5 of the second fibers per cm.

14. (canceled)

15. The hybrid fabric according to claim 1, wherein the first layer further comprises third fibers oriented in a third direction, wherein the second layer further comprises fourth fibers oriented in a fourth direction, wherein, the first fibers constitute from about 15 wt. % to about 80 wt. % of the total weight of the hybrid fabric, wherein the second fibers constitute from about from about 5 wt. % to about 50 wt. % of the total weight of the hybrid fabric, wherein the third fibers constitute from about 0 wt. % to about 50 wt. % of the total weight of the hybrid fabric; and wherein the fourth fibers constitute from about 0 wt. % to about 80 wt. % of the total weight of the hybrid fabric.

16. The hybrid fabric according claim 1, wherein the first layer has an areal weight in the range of about 20 wt. % to about 80 wt. % by total weight of the hybrid fabric, and wherein the second layer has an areal weight in the range of about 5 wt. % to about 75 wt. % of the total areal weight of the hybrid fabric.

17. A method of producing a carbon fiber and glass fiber hybrid fabric, the method comprising:
providing a first layer comprising a plurality of first fibers oriented in a first direction, the first fibers comprising carbon fibers;
providing a second layer comprising a plurality of second fibers oriented in a second direction, the second fibers comprising stabilization fibers;
stitching the first and second layers together using a stitching yarn to form the hybrid fabric having an areal weight of less than about 500 g/m²,
wherein the second layer is disposed on the first layer,
wherein the second direction is within about 45 degrees to about 90 degrees of the first direction,
wherein the first fibers oriented in the first direction constitute at least about 15 wt. % of the total weight of the hybrid fabric, and
wherein the second fibers orientated in the second direction constitute up to about 50 wt. % of the total weight of the hybrid fabric.

18-19. (canceled)
